(19) United States
(12) Patent Application Publication
(10) Pub. No.: US 2023/0243272 A1
(43) Pub. Date: Aug. 3, 2023

(54) GUIDE VANE ASSEMBLY FOR A TURBOMACHINE

(71) Applicant: MTU Aero Engines AG, München (DE)

(72) Inventor: Carsten Schoenhoff, Munich (DE)

(73) Assignee: MTU Aero Engines AG, München (DE)

(21) Appl. No.: 18/161,367

(22) Filed: Jan. 30, 2023

(30) Foreign Application Priority Data
Feb. 2, 2022 (DE) 10 2022 102 421.0

(51) Int. Cl. F01D 17/16

(52) U.S. Cl. CPC F01D 17/162; F05D 2240/12

(57) ABSTRACT

The present invention relates to a guide vane assembly for a turbomachine, having an adjustable vane, which can be adjusted in order to alter an angle of attack, and an adjusting element, by way of which the adjustable vane can be adjusted, wherein the adjustable vane and the adjusting element are connected to each other in a connecting region, and wherein the adjustable vane and the adjusting element adjoin each other in the connecting region at a break edge.

### BACKGROUND OF THE INVENTION

The present invention relates to a guide vane assembly with an adjustable vane for a turbomachine.

The turbomachine can involve, for example, a jet engine, such as, for example, a turbofan engine. Functionally, the turbomachine is divided into compressor, combustion chamber, and turbine. In the case of the jet engine, for instance, air intake is compressed by the compressor and undergoes combustion with admixed kerosene in the downstream combustion chamber. The hot gas that is formed, a mixture of combustion gas and air, flows through the downstream turbine and is thereby expanded. As a rule, both the compressor and the turbine are constructed from a plurality of stages, each of which has a stator (guide vane ring) and a rotor (rotating blade ring). Each vane or blade ring therefore has a plurality or a multiple number of vanes or blades distributed circumferentially.

In order to expand the operating range, for example, adjustable vanes or blades are utilized, in particular adjustable guide vanes in the compressor region. In the case of an adjustable vane, it is possible to vary the angle of attack or the inflow angle of the vane, for which purpose an adjustment system is provided. This adjustment system can comprise, for example, an adjustment ring that extends circumferentially around the longitudinal axis of the turbomachine and, for example, is actuated by way of a transmission mechanism. Regardless of the realization in an individual case, the displacement can then be transmitted to the adjustable vane by way of an adjusting element, such as, for example, an adjusting lever that is coupled to the adjustment ring, at least indirectly.

### SUMMARY OF THE INVENTION

The present invention is based on the technical problem of specifying an advantageous guide vane assembly for a turbomachine.

This problem is solved in accordance with the invention by the guide vane assembly of the present invention, wherein the adjustable vane and the adjusting element are connected to each other in a connecting region. The special feature in this case lies in the fact that the adjustable vane and the adjusting element in the connecting region adjoin each other at a break edge, namely, a break site that has been deliberately produced beforehand. Thus, the adjusting element and the adjustable vane each have a break surface and these break surfaces are brought together in the connecting region. As discussed below in detail, the adjusting element and the adjustable vane are initially produced as a one-piece part and the break edge is then produced by deliberate breaking. The temporary separation can simplify, for example, the installation of the guide vane assembly; that is, for example, the adjustable vane and the adjusting element can be assembled with a housing element more easily as separate parts.

On the other hand, the resulting break surfaces match each other exactly. That is, during later assembly of the adjustable vane and the adjusting element, the surfaces specify an exact relative position, so that the two parts can be brought together precisely. In consequence thereof, for example, it is not necessary to provide any separate alignment or fitting means and the connection can thus be executed, for example, without locating pins, thereby simplifying the connection and making possible a weight-optimized construction. The latter can also be of advantage, for example, in terms of energy efficiency in regard to aircraft engines. Regardless thereof, the reduction or elimination of connection tolerances, for example, can also increase the precision of the adjustment during operation.

Preferred embodiments are found in the dependent claims and in the entire disclosure, whereby, in the description of the features, a distinction is not always made in detail between device aspect and method or use aspects; in any case, the disclosure is to be read implicitly in terms of all claim categories. If, for example, a guide vane assembly that is produced in a certain way is described, it is to be understood at the same time as being a disclosure of the corresponding production method, and vice versa.

As explained below in detail, the break edge and the connecting region can be constructed, in particular, at a pin or journal of the adjustable vane, said pin lying radially inside of or preferably radially outside of the vane element in relation to the longitudinal axis of the turbomachine. The pin can lie, for example, on the adjustment axis of the adjustable vane, around which the adjustable vane is adjusted during operation, preferably coaxially with it.

In general, the adjustable vane and the adjusting element can be connected to each other in any desired way in a force-fitting manner and/or in a form-fitting manner. One possibility for realizing the connecting region can lie in a screw bolt connection; that is, a screw bolt can engage in one of the two parts and thereby apply pressure on the other part. The break edge or break surface can thereby extend, for example, circumferentially around the screw bolt. Thus, the break edge could separate, for example, a hollow-cylindrical section of the adjusting element from a hollow-cylindrical section of the pin of the adjustable vane, with the screw bolt then being seated and resting against one of the hollow-cylindrical sections and engaging by its thread in the other.

In accordance with a preferred embodiment, which, in particular, can represent an alternative to such a direct screw bolt connection, a sleeve is put in place in the connecting region and extends beyond the break edge. It is possible by way of the sleeve, for example, to optimize or maximize the fit of utilizable break surfaces and this can be of particular advantage, for example, in the case of small design spaces in high-pressure compressors, for instance.

The sleeve holds together the adjusting element and the adjustable vane. Preferably, to this end, it engages in the pin (see above) of the adjustable vane in a form-fitting manner. This form fit exists in the axial direction in relation to the pin axis, which preferably coincides with the adjustment axis of the adjustable vane. Preferably, at its end facing the adjustable vane, the sleeve can have a collar that projects radially inward in relation to the pin axis and is to be inserted or is inserted in a recess of the pin for the creation of the form fit.

The adjusting element is then fastened to the adjustable vane by tensioning the sleeve, which is held in a form-fitting manner, against the pin of the adjustable vane. In a preferred embodiment, this occurs by use of a screw bolt that engages in the sleeve and is supported on the adjusting element. The screw bolt applies tension to the sleeve, which is held in a form-sitting manner, and thereby presses the adjusting element towards the pin. Preferably, the screw bolt is screwed into an inner thread that is formed on the sleeve itself; that is, an inner thread is cut into the end of the sleeve that faces away from the vane element.

In a preferred embodiment, the sleeve is slit at least in one section, that is, at least in one axial section, towards one side; that is, the sleeve is radially open (in relation to the respective pin axis). Preferably, the sleeve is slit in such a way that it can be placed on the pin laterally and, accordingly, is relatively easy to mount. If an adjusting lever is provided as the adjusting element, the sleeve can be open towards the lever; that is, the slit lies facing the lever.

In accordance with a preferred embodiment, the break edge lies at a notch score; that is, for example, the break surface extends away from a notch provided on the outer wall of the pin. The notch can simplify the preceding separation or specify a position to the break edge.

In a preferred embodiment, a marking is provided and extends proportionately on both parts that are separated from each other by the break edge. The marking thereby extends over the break edge, for example, in the form of a line that is interrupted by the break edge. Even though the break edge as such specifies the relative position, the marking can simplify the assembly and/or make possible an inspection of the connection.

As mentioned above, the adjusting element is a lever in a preferred embodiment. In one stage, such as, for example, in a guide vane ring or in a module of the turbomachine, such as, for example, in a compressor module with a plurality of stages, the lever can then be connected to an adjustment ring, at least indirectly. By way of the adjustment ring, it is then possible, for example, to adjust all adjustable vanes of the respective stage in a synchronous manner. Preferably, in this case, each adjustable vane of the stage is connected to a respective lever at a respective break edge.

The invention also relates to a method for producing a presently disclosed guide vane assembly, wherein
i) the adjustable vane and the adjusting element are produced in one piece with each other;
ii) the adjustable vane and the adjusting element are afterwards separated from each other by breaking;
iii) the adjustable vane and the adjusting element are subsequently assembled in such a way that they adjoin each other at the break edge resulting from the break;
iv) the adjustable vane and the adjusting element are connected to each other in the connecting region.

The one-piece production in accordance with item i), in general, can also be produced, for example, by casting or additive manufacturing, such as, for example, in a powder bed method. In a preferred embodiment, however, the adjustable vane and the adjusting element are produced by forging, preferably by precision forging.

In accordance with a preferred embodiment, the adjustable vane and the adjusting element, which are produced in one piece with each other, are end-processed jointly prior to breaking, that is, while they are still in one piece. This end processing or finishing can be produced, for example, by removal of material, such as, for example, by grinding or by polishing, etc. The joint end finishing can also be of advantage in terms of the precision of the parts that are then later put back together.

In a preferred embodiment, the adjustable vane and the adjusting element are cooled for the breaking, it thereby being possible, for example, to favor the creation of a clean break edge. A cooling to below 0° C. can be preferred and, for example, can also be markedly lower with the use of liquid nitrogen.

For the later assembly, the adjustable vane and the adjusting element can be identified in a preferred embodiment, whereby, depending on the guide vane assembly, the adjustable vane and the adjusting element are furnished with the same identifications, but these identifications differ from one guide vane assembly to another. Such an identification can be provided, for example, in the form of a serial number, such as, for instance, a sequential serial number from one guide vane assembly to another. For each guide vane assembly, the parts thereby bear the same serial number, thus making it possible to simplify the assignment of the parts during assembly.

The invention also relates to a method for producing a module of a turbomachine, said module also having a housing element in addition to the guide vane assembly. The housing element can be, for example, part of the structure incorporating the gas duct, such as, for example, a structure bearing a gas duct plate or being such a gas duct plate. After breaking, the adjusting element and the vane are assembled with the housing element; that is, the adjusting element is placed, for example, between the lever and the vane element. Afterwards, the vane and the adjusting element are connected to each other by use of a screw bolt and/or clamping connection as discussed above, for example.

### BRIEF DESCRIPTION OF THE DRAWING FIGURES

The invention is explained below in detail on the basis of an exemplary embodiment, whereby, in the scope of the dependent claims, the individual features also can be essential to the invention in other combination and also, furthermore, no distinction is made in detail between the different claim categories.

Taken individually:

FIG. 1 shows a turbomachine in a schematic longitudinal sectional view;

FIG. 2 shows a guide vane assembly for such a turbomachine, with an adjustable vane and an adjusting element; and

FIG. 3 shows a detailed sectional view of the guide vane assembly in accordance with FIG. 2.

### DESCRIPTION OF THE INVENTION

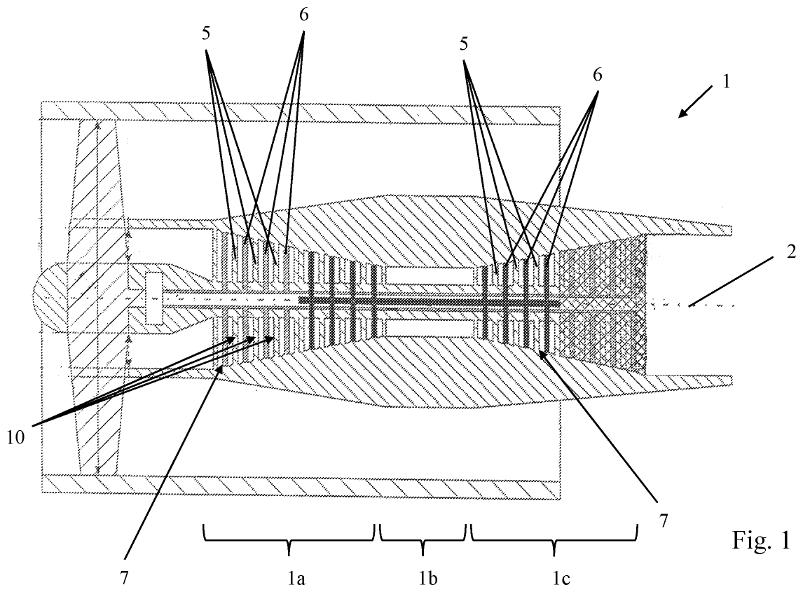

FIG. 1 shows a turbomachine 1, specifically a turbofan engine, in a longitudinal sectional view. Functionally, the turbomachine 1 is divided into a compressor 1a, a combustion chamber 1b, and a turbine 1c. Both the compressor 1a and the turbine 1c are each constructed from a plurality of stages. Each of the stages is composed of a guide vane ring 5 and a rotating blade ring 6. The reference number 7 refers to the gas duct, that is, the compressor gas duct in the case of the compressor 1a or the hot gas duct in the case of the turbine 1c. In the compressor gas duct, the air intake is compressed and then undergoes combustion with admixed kerosene in the combustion chamber 1b. The resulting hot gas flows through the hot gas duct and thereby drives the rotating blade rings 6 of the turbine 1c.

In the present example, a plurality of guide vane rings 5 of the compressor 1a are equipped with adjustable vanes 10, which can be adjusted for adaptation of the angle of attack (shown here for the low-pressure compressor, but likewise or alternatively also for the high-pressure compressor).

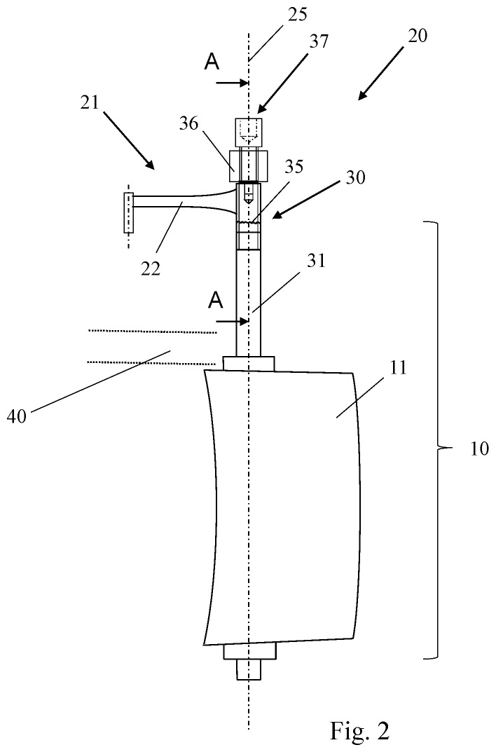

FIG. 2 shows a guide vane assembly 20 with such an adjustable vane 10 and an adjusting element 21. The latter involves an adjusting lever 22, by use of which the adjustable vane 10 can be rotated or displaced around an adjustment axis 25. The adjusting element 21 is connected to the adjustable vane 10 in a connecting region 30. The connecting region 30 is formed on a pin 31 of the adjustable vane 10, said pin being arranged radially outside of the vane element 11 in relation to the longitudinal axis 2 of the turbomachine.

In this case, specifically the pin 31 of the adjustable vane 10 and the adjusting element 21 adjoin each other at a break edge 35. For this purpose, the two of them are initially produced in one piece with each other and they are then separated from each other by deliberate breaking. Once separated from each other, the two parts can then be handled better and, for example, can be assembled with a housing element 40, which is shown here only schematically; on the other hand, the break edge 35 specifies here a defined relative position.

As presented in the introduction of the description in detail, this can be of advantage, for example, in regard to the precision and also the weight of the entire structure. In the present example, the connection between the adjustable vane 10 and the adjusting element 21 is realized with the use of a sleeve 36, which extends beyond the break edge 35 and pulls the adjusting element 21 against the pin 31. To this end, the sleeve 36 is tensioned against the pin 31 by use of a screw bolt 37, which is supported against the adjusting element 21.

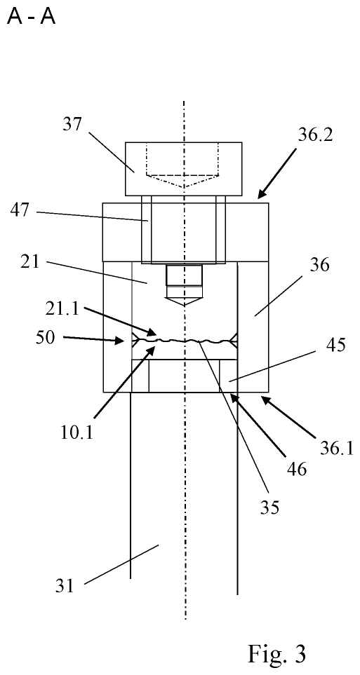

FIG. 3 shows this arrangement in a detailed sectional view in which the axis of the sectional view is perpendicular to the plane of the drawing in accordance with FIG. 2. The sectional view shows that the sleeve 36 extends beyond the break edge 35; this cannot be seen in FIG. 2 in a straightforward manner on account of a lateral slit of the sleeve 36, which makes possible its lateral placement. At the end 36.1 facing the vane element 11, the sleeve has an inwardly projecting collar 45, which engages in a recess 46 of the pin 31 in a form-fitting manner. The sleeve 36 is thereby held at the pin 31 in a form-fitting manner. The screw bolt 37 engages in an inner thread 47 at the end 36.2 of the sleeve 36 facing away from the vane element 11 and rests against the adjusting element 21 and thus applies tension against the sleeve 36. Accordingly, the two parts are pressed towards each other at the break edge 35; that is, the break surfaces 10.1, 21.1 of the adjustable vane 10 and of the adjusting element 21 are pressed against each other.

In this detailed illustration, furthermore, a notch 50 can be seen, which specifies a defined position of the break edge 35 during the breaking.

What is claimed is:

1. A guide vane assembly for a turbomachine, comprising:
an adjustable vane, which can be adjusted in order to alter an angle of attack, and an adjusting element, by way of which the adjustable vane can be adjusted;
wherein the adjustable vane and the adjusting element are connected to each other in a connecting region;
and wherein the adjustable vane and the adjusting element adjoin each other in the connecting region at a break edge.

2. The guide vane assembly according to claim 1, wherein a sleeve is put in place in the connecting region and extends beyond the break edge and connects together the adjustable vane and the adjusting element.

3. The guide vane assembly according to claim 2, wherein the sleeve engages at a pin of the adjustable vane in a form-fitting manner and tensions it against the latter.

4. The guide vane assembly according to claim 3, wherein the sleeve is placed under tension with a screw bolt, which engages in the sleeve and supports it on the adjusting element.

5. The guide vane assembly according to claim 2, wherein the sleeve is slit, at least in sections.

6. The guide vane assembly according to claim 1, wherein the break edge lies at a notch.

7. The guide vane assembly according to claim 1, wherein a marking that is interrupted by the break edge extends over the break edge.

8. The guide vane assembly according to claim 1, wherein the adjusting element is an adjusting lever, which is assembled together with a pin of the adjustable vane.

9. A module for a turbomachine, having a guide vane assembly according to claim 1 and a housing element, with which the guide vane assembly is assembled.

10. A method for producing the guide vane assembly according to claim 1, wherein:
i) the adjustable vane and the adjusting element are produced in one piece with each other;
ii) the adjustable vane and the adjusting element are separated from each other afterwards by breaking;
iii) the adjustable vane and the adjusting element are subsequently assembled so that they adjoin each other at the break edge resulting from the breaking;
iv) the adjustable vane and the adjusting element are connected to each other in the connecting region.

11. The method for production of the guide vane assembly according to claim 10, wherein the adjustable vane and the adjusting element are produced in step i) by forging.

12. The method according to claim 10, wherein the adjustable vane and the adjusting element are end-processed prior to step ii).

13. The method according to claim 10, wherein the adjustable vane and the adjusting element are cooled for step ii).

14. The method according to claim 10, wherein the adjustable vane and the adjusting element are furnished with the same identifications and are assigned to each other in step iii) on the basis of these identifications.

15. A method for producing a module of a turbomachine, comprising:
a housing element; and
a guide vane assembly, which is produced according to the method of claim 10;
wherein the adjustable vane and the adjusting element are assembled with the housing element after step ii) and prior to step iv).
